(19) United States
(12) Patent Application Publication
(10) Pub. No.: US 2012/0166673 A1
(43) Pub. Date: Jun. 28, 2012

(54) MESSAGE ROUTING METHOD AND MESSAGE ROUTING DEVICE

(75) Inventor: Duojun Lu, Nanjing (CN)

(73) Assignee: Huawei Technologies Co., Ltd., Shenzhen (CN)

(21) Appl. No.: 13/412,004

(22) Filed: Mar. 5, 2012

Related U.S. Application Data
(63) Continuation of application No. PCT/CN2010/076723, filed on Sep. 8, 2010.

(30) Foreign Application Priority Data
Sep. 8, 2009 (CN) 200910169536.5

(51) Int. Cl. G06F 15/173

(52) U.S. Cl. 709/238

(57) ABSTRACT

A message routing method and a message routing device are provided, where the message routing method includes: performing Extensible Markup Language (XML) transformation on content of an XML message by using an XML transformation language including a route policy, and obtaining a target message after the XML transformation, where the route policy includes an operation rule for performing the XML transformation on the content of the XML message, and the XML transformation language includes an Extensible Stylesheet Language (XSL); and routing the XML message to a message receiving subject according to the target message. Through the method and the device according to the embodiments of the present invention, various operations performing on the content of the XML message are set in the XML transformation language, so the route policy may be flexibly configured, thereby implementing the routing on the basis of the content of the XML message.

### CROSS-REFERENCE TO RELATED APPLICATIONS

This application is a continuation of International Application No. PCT/CN2010/076723, filed on Sep. 8, 2010, which claims priority to Chinese Patent Application No. 200910169536.5, filed on Sep. 8, 2009, both of which are hereby incorporated by reference in their entireties.

### FIELD OF THE INVENTION

The present invention relates to the field of communications technologies, and in particular, to a message routing method and a message routing device.

### BACKGROUND OF THE INVENTION

At present, a message routing method is implemented through the cooperation of a message-oriented middleware and service address registration. As shown in FIG. 1, service address information of a plurality of message receiving subjects (the message receiving subjects A, B and C) is registered in a service registry center, and the service registry center provides a data inquiring interface for the message-oriented middleware. When receiving a request message each time, the message-oriented middleware inquires the service registry center about a service address of the message receiving subject, and routes the request message to a corresponding message receiving subject after finding the service address matching with the request message.

In the implementation of the present invention, the inventor finds that the prior art at least has the following problems.

Since the data inquiring interface in the service registry center is usually based on a certain standard, such as Universal Description, Discovery, and Integration (UDDI), and these standards provide inquiring according to some preset feature values (such as a service interface name and a service data version number) of service registration data, and a defect that inquiring conditions are limited exists.

### SUMMARY OF THE INVENTION

Embodiments of the present invention provide a message routing method and a message routing device, where routing is performed on the basis of message content according to a route policy, wherein routing is performed on the basis of message content, and a route policy has flexible configuration.

A message routing method includes:

performing Extensible Markup Language (XML) transformation on content of an XML message by using an XML transformation language including a route policy, and obtaining a target message after the XML transformation, where the route policy includes an operation rule for performing the XML transformation on the content of the XML message, and the XML transformation language includes an Extensible Stylesheet Language (XSL); and

routing the XML message to a message receiving subject according to the target message.

A message routing device includes:

a transformation unit, configured to perform XML transformation on content of an XML message by using an XML transformation language including a route policy, and obtain a target message after the XML transformation, where the route policy includes an operation rule for performing the XML transformation on the content of the XML message, and the XML transformation language includes an XSL; and

a routing unit, configured to route the XML message to a message receiving subject according to the target message.

It can be seen from the above technical solutions provided by the embodiments of the present invention that, various operations performing on the content of the XML message may be set in the XML transformation language, so the route policy may be flexibly configured, thereby implementing the routing on the basis of the content of the XML message.

### BRIEF DESCRIPTION OF THE DRAWINGS

To illustrate the technical solutions in the embodiments of the present invention or in the prior art clearer, the accompanying drawings for describing the embodiments or the prior art are introduced briefly in the following. Apparently, the accompanying drawings in the following description are only some embodiments of the present invention, and persons of ordinary skill in the art may further derive other drawings from the accompanying drawings without creative efforts.

FIG. 1 is a schematic principle diagram of a message routing method in the prior art;

FIG. 2 is a flow chart 1 of a message routing method according to an embodiment of the present invention;

FIG. 3 is a schematic structure diagram 1 of a message routing device according to an embodiment of the present invention;

FIG. 4 is a schematic structure diagram 2 of a message routing device according to an embodiment of the present invention;

FIG. 5 is an application flow chart 1 of a message routing method according to an embodiment of the present invention;

FIG. 6 is an application flow chart 2 of a message routing method according to an embodiment of the present invention; and

FIG. 7 is a schematic application diagram of a message routing device according to an embodiment of the present invention.

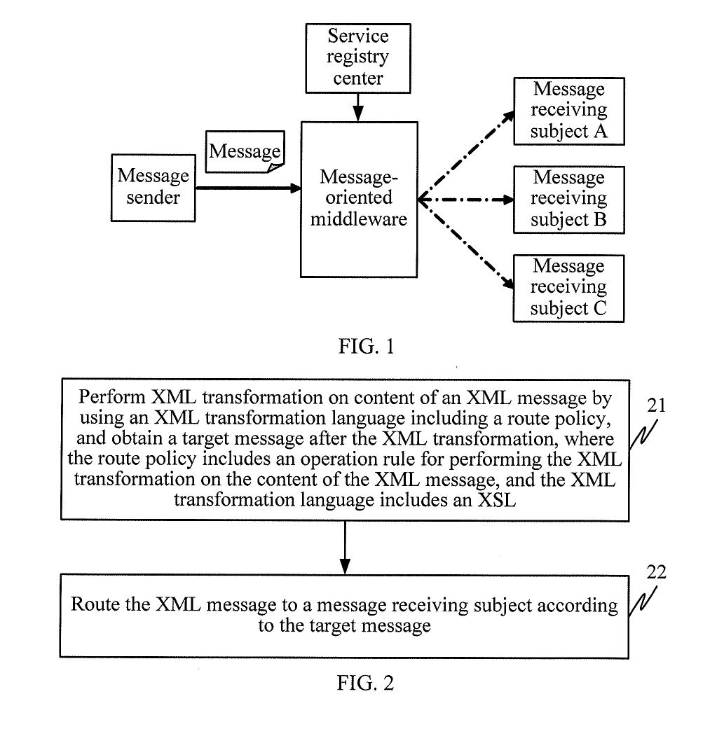

### DETAILED DESCRIPTION OF THE EMBODIMENTS

The following describes the technical solution in the present invention clearly and completely with reference to the accompanying drawings. Apparently, the embodiments to be described are only a part rather than all of the embodiments of the present invention. All other embodiments obtained by persons skilled in the art based on the embodiments of the present invention without creative efforts shall fall within the protection scope of the present invention.

An XML is used to describe data, and indicate data content through an element value of the XML.

An XSL is used to define a transformation rule and a transformation result of the XML, and present the XML data through a readable format, and belongs to an XML transformation language. The XML can be transformed into a text or a message in any format through XSL Transformations (XSLT), such as Hypertext Marked Language (HTML) and Comma Separated values (CSV).

XPath (a navigation language) is used to adopt the XSL to inquire, traverse, sort, and perform some logical operations on the element values of the XML during the XML transformation.

The message routing method according to the prior art has the defects that inquiring conditions are limited, and the inquiring cannot be performed according to the changed message content. The embodiments of the present invention provide a message routing method and a message routing device. Various operations performing on the content of the XML message may be set in the XML transformation language, so the route policy may be flexibly configured, thereby implementing the routing on the basis of the content of the XML message.

### Embodiment 1

As shown in FIG. 2, an embodiment of the present invention provides a message routing method, including the following.

Step 21: Perform XML transformation on content of an XML message by using an XML transformation language including a route policy, and obtain a target message after the XML transformation, where the route policy includes an operation rule for performing the XML transformation on the content of the XML message, and the XML transformation language includes an XSL. The operation rule may further include the corresponding target message after performing the XML transformation on the XML message.

Step 22: Route the XML message to a message receiving subject according to the target message.

The XML transformation language may include the XSL.

It can be known from the above that, various operations performing on the content of the XML message may be set in the XML transformation language, so the route policy may be flexibly configured, thereby implementing the routing on the basis of the content of the XML message.

Optionally, in the message routing method according to the embodiment of the present invention, the XML transformation language including the route policy may include the following.

The route policy is set in the XML transformation language according to the operation rule for performing the XML transformation on the content of the XML message.

Specifically, the route policy is set in the XSL. It may be understood that, when the routing rule is changed, the XSL setting is correspondingly changed, and a route of the XML message may be changed accordingly.

Optionally, through the message routing method according to the embodiment of the present invention, when the target message is a route address of the message receiving subject, the XML message may be routed to the message receiving subject according to the route address. The route address may be a uniform resource locator (URL) address. Alternatively, when the target message has a corresponding route address of the message receiving subject, the corresponding route address needs to be obtained according to the target message, and the XML message is routed to the message receiving subject according to the route address.

When the target message has the corresponding route address of the message receiving subject, a route table may be created for storing the target message and the corresponding route address of the message receiving subject. That is to say, after the XML transformation is performed on the content of the XML message, the target message is obtained, and the route address of the message receiving subject may be obtained through mapping of the route table. More flexible routing configuration may be implemented by using the route table, for example, if the address of a certain message receiving subject is changed, it is merely required to change the route address of the certain message receiving subject in the route table.

A corresponding relation between the target message and the route address of the message receiving subject is the route table, and the route policy may further include the route table in addition to the operation rule, that is, the XML message is routed to the message receiving subject according to the corresponding relation between the target message after the XML transformation and the address of the message receiving subject.

That is to say, the target message obtained through the operation is the address of the XML message receiving subject, or the target message obtained through the operation is a middle value, and the address of the XML message receiving subject is obtained according to the middle value and the route table.

Further, through the message routing method according to the embodiment of the present invention, during the XML transformation, XPath is used to inquire, traverse, sort, and perform some logical operations on element values of the XML, so that the route policy may be more flexibly configured, thereby implementing the route policy on the basis of the message content.

It can be seen from the foregoing technical solution provided by the embodiment of the present invention that, the XML transformation is performed on the content of the XML message by using the XML transformation language XSL including the route policy, and the target message after the XML transformation is obtained, where the route policy includes the operation rule for performing the XML transformation on the content of the XML message. Various operations performing on the content of the XML message may be set in the XML transformation language, so the route policy may be flexibly configured, thereby implementing the routing on the basis of the content of the XML message. In addition, the target message after the XML transformation is obtained by performing the XML transformation on the content of the XML message, and the routing may be implemented on the basis of the content of the XML message accordingly, thereby avoiding an influence on system efficiency and the influence from a network since a message-oriented middleware needs to interact with a service registry center each time when a request message is received in the prior art.

### Embodiment 2

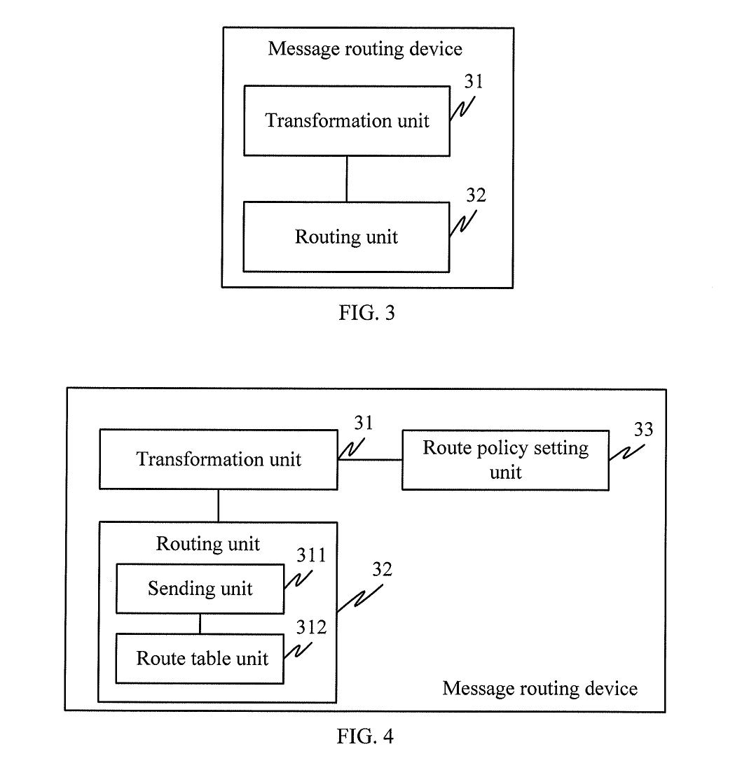

As shown in FIG. 3, an embodiment of the present invention provides a message routing device, including:

a transformation unit 31, configured to perform XML transformation on content of an XML message by using an XML transformation language including a route policy, and obtain a target message after the XML transformation, where the route policy includes an operation rule for performing the XML transformation on the content of the XML message, and the XML transformation language includes an XSL; and

a routing unit 32, configured to route the XML message to a message receiving subject according to the target message.

It can be known from the above that, various operations performing on the content of the XML message may be set in the XML transformation language, so the route policy may be flexibly configured, thereby implementing the routing on the basis of the content of the XML message.

As shown in FIG. 4, the message routing device according to the embodiment of the present invention may further include:

a route policy setting unit 33, configured to set the route policy in the XML transformation language, or further set the route policy in a route table according to the operation rule for performing the XML transformation on the content of the XML message.

When the route policy based on the content of the XML message is changed, the XML transformation language in the route policy setting unit 33 is correspondingly changed, and a route of the XML message may be changed accordingly.

Optionally, the routing unit 32 may include:

a sending unit 311, configured to route the XML message to the message receiving subject according to a route address when the target message is the route address of the message receiving subject; and

a route table unit 312, configured to configure and store the route address of the message receiving subject for the target message. At this time, the sending unit 311 is configured to determine the route address of the message receiving subject corresponding to the target message from the route table unit, and route the XML message to the message receiving subject according to the route address.

The table application is obtained through the route table unit 312 to implement more flexible routing configuration, for example, if the route address of a certain message receiving subject is changed, it is merely required to change the route address of the message receiving subject in the route table. The route address may be a URL address.

The XML transformation language of the transformation unit 31 may use a navigation language XPath to inquire, traverse, sort, and perform some logical operations on element values of the XML, so that the route policy may be more flexibly configured, thereby implementing the route policy on the basis of the message content.

The message routing device according to the embodiment of the present invention may be applied in a message-oriented middleware (for example, an Enterprise Service Bus (ESB), which is a distributed middleware) and common application based on the XML message. Through the message routing device according to the embodiment of the present invention, when the XML message is input, the route address of the message receiving subject satisfying the route policy may be output on the basis of the content of the XML message.

It can be seen from the foregoing technical solution provided by the embodiment of the present invention that, the XML transformation is performed on the content of the XML message by using the XML transformation language XSL including the route policy, and the target message after the XML transformation is obtained, where the route policy includes the operation rule for performing the XML transformation on the content of the XML message. Various operations performing on the content of the XML message may be set in the XML transformation language, so the route policy may be flexibly configured, thereby implementing the routing on the basis of the content of the XML message. In addition, the target message after the XML transformation is obtained by performing the XML transformation on the content of the XML message, and the routing may be implemented on the basis of the content of the XML message accordingly, thereby avoiding an influence on system efficiency and the influence from a network since a message-oriented middleware needs to interact with a service registry center each time when receiving a request message in the prior art.

### Embodiment 3

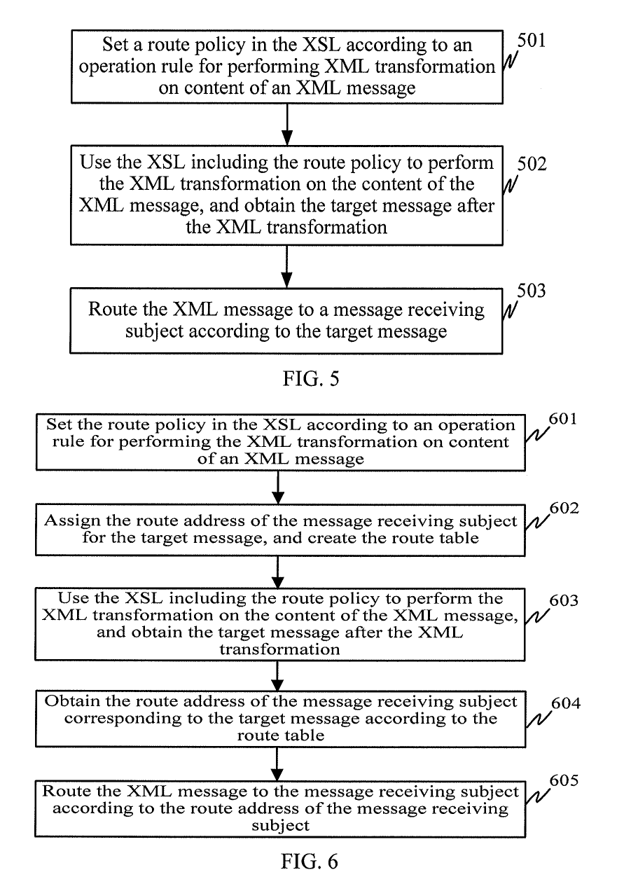

As shown in FIG. 5, the case that an XML transformation language is an XSL, and a target message (Route Value) after XML transformation is a route address of a message receiving subject (Service Provider) is taken as an example to describe a message routing method according to the embodiment of the present invention in details.

501: Set a route policy in the XSL according to an operation rule for performing XML transformation on content of an XML message and the corresponding target message after the XML transformation.

A: Set the route policy on the basis of the content of the XML message.

For example, the XML message has the following formats:

<?xml version=‘1.0’ encoding=‘UTF-8’?>
<sampleMsg>
<msgField1>111</msgField1>
<msgField2>222</msgField2>
<msgFieldA>aaa</msgFieldA>
</sampleMsg>,

where, msgField is an element of the XML message, and 111, 222, or aaa indicates an element value.

An operation rule for the XML transformation may be created on the basis of a value range of the element values of msgField1 and msgField2 of the XML message, and the target message after the XML transformation is a route address of the message receiving subject, and therefore, the following route policy may be set, which is as shown in Table 1:

| msgField1 | msgField2 | Target message (Route Value) |
|---|---|---|
| Smaller than 100 | Smaller than 200 | http://receiver0.com/service |
| Smaller than 100 | Larger than 200 | ftp://receiver1.com/files |
| Larger than 100 | Smaller than 200 | https://receiver2.com:9880/service |
| Larger than 100 | Larger than 200 | file:///C:/receiver3/docs/myMsgs |

In Table 1, the route address of the message receiving subject is a URL address.

B: Set the route policy in the XSL:

```
    <?xml version=‘1.0’ encoding=‘UTF-8’?>
    <xsl:stylesheet version=“1.0”
    xmlns:xsl=“http://www.w3.org/1999/XSL/Transform”>
    <xsl:template match=“/”>
    <xsl:if test=“sampleMsg/msgField1 &lt; 100 and
sampleMsg/msgField2 &lt; 200”> http://receiver0.com/service </xsl:if>
    <xsl:if test=“sampleMsg/msgField1 &lt; 100 and
sampleMsg/msgField2 &gt; 200”> ftp://receiver1.com/files </xsl:if>
    <xsl:if test=“sampleMsg/msgField1 &gt; 100 and
sampleMsg/msgField2 &lt; 200”> https://receiver2.com:9880/service
</xsl:if>
    <xsl:if test=“sampleMsg/msgField1 &gt; 100 and
sampleMsg/msgField2 &gt; 200”> file:///C:/receiver3/docs/myMsgs
</xsl:if>
    </xsl:template>
    </xsl:stylesheet>.
```

Where, &gt; and &lt; are XML entity references, and respectively indicate “larger than” and “smaller than”. The XSL includes the operation rule for performing the XML transformation on the XML message in the foregoing formats and the URL address of the message receiving subject after the XML transformation. That is, the XML transformation is performed on the values of elements msgField1 and msgField2 in the XML message by using the XSL including the route policy, and one of four target messages may be obtained, for example, http://receiver0.com/service, ftp://receiver1.com/files, https://receiver2.com:9880/service, or file:///C:/receiver3/docs/myMsgs.

502: Use the XSL including the route policy to perform the XML transformation on the content of the XML message, and obtain the target message after the XML transformation.

The XML message is received, and the element values of msgField1 and msgField2 in the XML message are obtained, for example, the value of msgField1 is 111, and the value of msgField2 is 222.

After XPath is used as a navigation language to perform the XML transformation on the values of msgField1 and msgField2 in the XML message, for example, the value of msgField1 is 111, and the value of msgField2 is 222, which satisfies the route policy that msgField1 is larger than 100 and msgField2 is larger than 200, the target message file:///C:/receiver3/docs/myMsgs corresponding to the route policy is obtained.

503: Route the XML message to a message receiving subject according to the target message.

For example, the XML message is routed to the message receiving subject of file:///C:/receiver3/docs/myMsgs according to the target message file:///C:/receiver3/docs/myMsgs.

It can be seen from the above technical solution provided by the embodiment of the present invention that, various operations performing on the content of the XML message may be set in the XSL, so the route policy may be flexibly configured, thereby implementing the routing on the basis of the content of the XML message.

### Embodiment 4

As shown in FIG. 6, the case that an XML transformation language is an XSL, and a target message (Route Value) after XML transformation is a route address of a message receiving subject (Service Provider) is taken as an example to describe a message routing method according to the embodiment of the present invention in details.

601: Set the route policy in the XSL according to an operation rule for performing the XML transformation on content of an XML message.

A: Set the route policy on the basis of the content of the XML message.

For example, the XML message has the following formats:

```
<?xml version=‘1.0’ encoding=‘UTF-8’?>
<sampleMsg>
  <msgField1>111<msgField1>
  <msgField2>222</msgField2>
  <msgFieldA>aaa</msgFieldA>
< /sampleMsg>,
```

where, msgField is an element of the XML message, and 111, 222, or aaa indicates an element value.

The operation rule for the XML transformation may be created on the basis of a value range of the element values of msgField1 and msgField2 of the XML message, and the target message after the XML transformation is an identifier, and it is required to obtain the route address of the message receiving subject corresponding to the target message through a route table, and therefore, the following route policy may be set, which is as shown in Table 2:

| | | Target message |
|---|---|---|
| msgField1 | msgField2 | (Route Value) |
| Smaller than 100 | Smaller than 200 | Receiver0 |
| Smaller than 100 | Larger than 200 | Receiver1 |
| Larger than 100 | Smaller than 200 | Receiver2 |
| Larger than 100 | Larger than 200 | Receiver3 |

B: Set the route policy in the XSL:

```
    <?xml version=‘1.0’ encoding=‘UTF-8’?>
    <xsl:stylesheet version=“1.0”
    xmlns:xsl=“http://www.w3.org/1999/XSL/Transform”>
    <xsl:template match=“/”>
    <xsl:if test=“sampleMsg/msgField1 &lt; 100 and
sampleMsg/msgField2 &lt; 200”>receiver0</xsl:if>
    <xsl:if test=“sampleMsg/msgField1 &lt; 100 and
sampleMsg/msgField2 &gt; 200”>receiver1</xsl:if>
    <xsl:if test=“sampleMsg/msgField1 &gt; 100 and
sampleMsg/msgField2 &lt; 200”>receiver2</xsl:if>
    <xsl:if test=“sampleMsg/msgField1 &gt; 100 and
sampleMsg/msgField2 &gt; 200”>receiver3</xsl:if>
    </xsl:template>
    </xsl:stylesheet>
```

where &gt; and &lt; are XML entity references, and respectively indicate “larger than” and “smaller than”. The XSL includes the operation rule for performing the XML transformation on the XML message in the foregoing formats and the target message after the XML transformation. That is, the XML transformation is performed on the values of the elements msgField1 and msgField2 in the XML message by using the XSL including the route policy, and one of four target messages may be obtained, for example, receiver0, receiver1, receiver2, and receiver3.

602: Assign the route address of the message receiving subject for the target message, and create the route table.

The route table is created, which includes a corresponding relation between the target message and the route addresses of the message receiving subject. For example, the route table is defined for receiver0, receiver1, receiver2 and receiver3, which is as shown in Table 3:

| Target message | URL address of the message |
|---|---|
| (Route Value) | receiving subject |
| Receiver0 | http://receiver0.com/service |
| receiver1 | ftp://receiver1.com/files |
| receiver2 | https://receiver2.com:9880/service |
| receiver3 | file:///C:/receiver3/docs/myMsgs |

In Table 3, the route address is, for example, the URL address of the message receiving subject.

603: Use the XSL including the route policy to perform the XML transformation on the content of the XML message, and obtain the target message after the XML transformation.

The XML message is received, and the element values of msgField1 and msgField2 in the XML message are obtained, for example, the value of msgField1 is 111, and the value of msgField2 is 222.

After XPath is used as a navigation language to perform the XML transformation on the values of msgField1 and msgField2 in the XML message, for example, the value of msgField1 is 111, and the value of msgField2 is 222, which satisfies the route policy that msgField1 is larger than 100 and msgField2 is larger than 200, the target message corresponding to the route policy “receiver3” is obtained.

604: Obtain the route address of the message receiving subject corresponding to the target message according to the route table.

The route address of the message receiving subject corresponding to the target message is obtained from the route table. For example, as for the target message “receiver3”, the address of the message receiving subject file:///C:/receiver3/docs/myMsgs is obtained from the route table.

605: Route the XML message to the message receiving subject according to the route address of the message receiving subject.

For example, the XML message is routed to the message receiving subject of file:///C:/receiver3/docs/myMsgs according to the route address of the message receiving subject.

If in 604, the address of the message receiving subject corresponding to the target message fails to be found in the route table, an inquiring result “null” is returned.

It can be seen from the above technical solution provided by the embodiment of the present invention that, various operations performing on the content of the XML message may be set in the XSL, so the route policy may be flexibly configured, thereby implementing the routing on the basis of the content of the XML message.

### Embodiment 5

The following describes a message routing device according to the embodiment of the present invention with reference to the foregoing Embodiment 3 and Embodiment 4.

A route policy setting unit 33 is configured to set a route policy in the XSL according to an operation rule for performing XML transformation on content of an XML message. Definitely, a generalized route policy further includes a corresponding relation between a target message and a route address of a receiving subject in a route table.

The target message may be the route address of the message receiving subject. Alternatively, a route table unit 312 creates a route table, so as to configure and store the route address of the message receiving subject for the target message.

A transformation unit 31 is configured to per form the XML transformation on the content of the XML message by using the XSL including the route policy after receiving the XML message, and obtain the target message after the XML transformation.

A sending unit 311 is configured to route the XML message to the message receiving subject according to a route address when the target message is the route address of the message receiving subject.

Alternatively, when the target message has the corresponding route address of the message receiving subject, the sending unit 311 determines the route address of the message receiving subject corresponding to the target message from the route table unit 312, and routes the XML message to the message receiving subject according to the route address.

### Embodiment 6

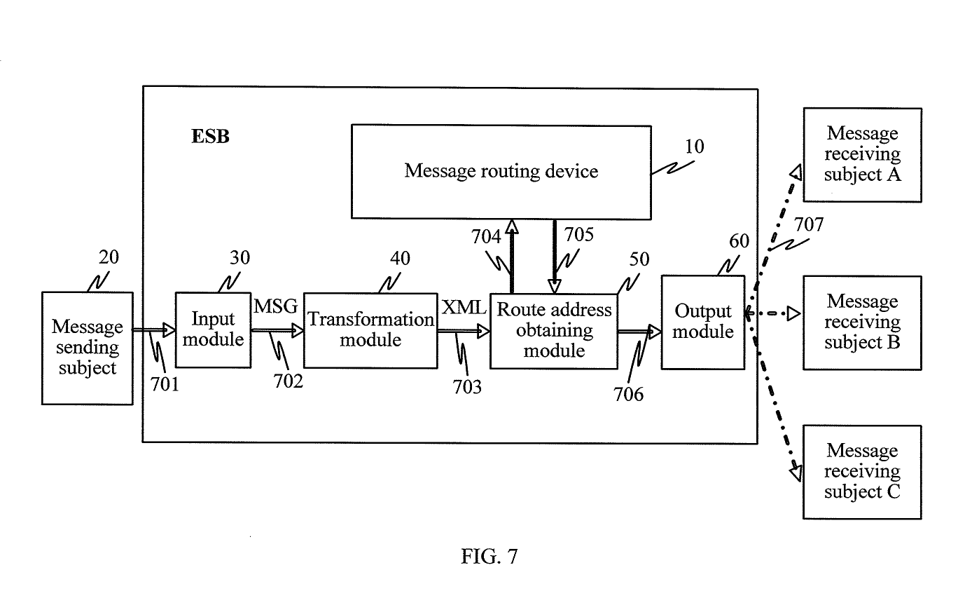

As shown in FIG. 7, a message routing device is applied in an ESB, and the case that the XML transformation language is an XSL, and a target message after XML transformation is a route address of a message receiving subject is taken as an example to describe a message routing device according to the embodiment of the present invention in details, where the ESB has a message transformation capability, and may transform a common message (an MSG message) into an XML message.

701: A message sending subject 20 sends a common message to an input module 30 of the ESB.

The message sending subject 20 sends the common message to the ESB, and specifically, the input module 30 of the ESB receives the common message.

702: The input module 30 sends the common message to a transformation module 40 of the ESB.

After receiving the common message, the input module 30 sends the common message to the transformation module 40, and the transformation module 40 transforms the common message into the XML message.

703: The transformation module 40 sends the XML message to a route address obtaining module 50.

After the transformation module 40 transforms the common message into the XML message, the route address obtaining module 50 receives the XML message.

704: The route address obtaining module 50 sends the XML message to the message routing device 10.

After receiving the XML message, the route address obtaining module 50 sends the XML message to the message routing device 10.

Referring to step 301 in Embodiment 3, the message routing device 10 sets a route policy in the XSL in advance according to an operation rule for performing the XML transformation on the content of the XML message, which is not described in detail here again.

After receiving the XML message, the message routing device 10 performs the XML transformation on the XML message, and obtains a target message after the XML transformation, where the target message is the route address of the message receiving subject.

705: The message routing device 10 sends the route address of the message receiving subject to the route address obtaining module 50.

After obtaining the route address of the message receiving subject, the message routing device 10 sends the route address to the route address obtaining module 50.

706: The route address obtaining module 50 sends the route address of the message receiving subject to an output module 60.

707: The output module 60 sends the XML message to the message receiving subject.

The output module 60 sends the XML message to the message receiving subject according to the route address of the message receiving subject. For example, the output module 60 sends the XML message to a message receiving subject A.

It should be understood that, as shown in FIG. 7, the message routing device 10 may be built in application of the ESB or other middleware. Alternatively, the message routing device 10 may be disposed separately from the ESB or other middleware. The input module 30, the transformation module 40, the address obtaining module 50, and the output module 60 of the ESB are existing modules on the ESB, which are not described in detail here.

Those of ordinary skill in the art may understand that all or a part of the processes of the method according to the embodiments of the present invention may be implemented by a program instructing relevant hardware. The program may be stored in a computer readable storage medium. When the program is run, the processes of the method according to the embodiments of the present invention are performed. The storage medium may be a magnetic disk, an optical disk, a read-only memory (ROM), or a random access memory (RAM).

The above descriptions are merely exemplary embodiments of the present invention, but the protection scope of the present invention is not limited hereto. Any modification, equivalent replacement, or improvement made by persons skilled in the art without departing from the spirit and principle of the present invention should fall within the protection scope of the present invention. Therefore, the protection scope of the present invention is subject to the protection scope of the claims.

What is claimed is:

1. A message routing method, comprising:
performing Extensible Markup Language (XML) transformation on content of an XML message by using an XML transformation language that comprises a route policy, and obtaining a target message after the XML transformation, wherein the route policy comprises an operation rule for performing the XML transformation on the content of the XML message, and
routing the XML message to a message receiving subject according to the target message.

2. The message routing method according to claim 1, wherein the XML transformation language is an Extensible Stylesheet Language (XSL).

3. The message routing method according to claim 2, wherein the routing the XML message to the message receiving subject according to the target message comprises:
routing the XML message to the message receiving subject according to a route address when the target message is the route address of the message receiving subject.

4. The message routing method according to claim 2, wherein the routing the XML message to the message receiving subject according to the target message comprises:
obtaining a corresponding route address according to the target message when the target message has the corresponding route address of the message receiving subject, and routing the XML message to the message receiving subject according to the route address.

5. The message routing method according to claim 4, wherein a corresponding relation between the target message and the route address of the message receiving subject is a route table, and the route policy further comprises: routing the XML message to the message receiving subject according to the corresponding relation between the target message after the XML transformation and the address of the message receiving subject.

6. The message routing method according to claim 2, wherein the method further comprises: obtaining an address of the XML message receiving subject according to a middle value and a route table when the target message is the address of the XML message receiving subject, or the target message is the middle value.

7. The message routing method according to claim 6, wherein the XSL uses a navigation language XPath to perform an operation on the content of the XML message.

8. The message routing method according to claim 4, wherein the route address is a uniform resource locator (URL) address.

9. A message routing device, comprising:
a transformation unit, configured to perform Extensible Markup Language (XML) transformation on content of an XML message by using an XML transformation language that comprises a route policy, and obtain a target message after the XML transformation, wherein the route policy comprises an operation rule for performing the XML transformation on the content of the XML message, and
a routing unit, configured to route the XML message to a message receiving subject according to the target message.

10. The message routing device according to claim 9, wherein the XML transformation language includes an Extensible Stylesheet Language (XSL).

11. The message routing device according to claim 10, wherein the device further comprises:
a route policy setting unit, configured to set a route policy in the XML transformation language according to an operation rule for performing the XML transformation on the content of the XML message.

12. The message routing device according to claim 11, wherein the route unit comprises:
a sending unit, configured to route the XML message to the message receiving subject according to a route address when the target message is the route address of the message receiving subject.

13. The message routing device according to claim 11, wherein the route unit comprises:
a route table unit, configured to configure and store a route address of the message receiving subject for the target message; and
a sending unit, configured to determine the route address of the message receiving subject corresponding to the target message from the route table unit, and route the XML message to the message receiving subject according to the route address.

14. The message routing device according to claim 13, wherein the XSL in the transformation unit uses a navigation language XPath to perform an operation on the content of the XML message.

15. The message routing device according to claim 13, wherein the route address is a uniform resource locator (URL) address.
